(19) United States
(12) Patent Application Publication
(10) Pub. No.: US 2013/0326627 A1
(43) Pub. Date: Dec. 5, 2013

(54) APPARATUS AND METHOD FOR DETECTING VULNERABILITY

(71) Applicant: Liang Zhao, Beijing (CN)

(72) Inventor: Liang Zhao, Beijing (CN)

(73) Assignee: NSFOCUS INFORMATION TECHNOLOGY CO., LTD., Beijing (CN)

(21) Appl. No.: 13/997,796

(22) PCT Filed: Jan. 17, 2012
(86) PCT No.: PCT/CN2012/000080

§ 371 Date: Jun. 25, 2013

(30) Foreign Application Priority Data
Jan. 17, 2011 (CN) 201110008981.0

(51) Int. Cl. H04L 29/06

(52) U.S. Cl. CPC H04L 63/1433
USPC 726/25

(57) ABSTRACT

The invention discloses a vulnerability monitoring method for performing a vulnerability monitoring on a system in which data execution protection (DEP) is enabled, which method comprises the steps of: monitoring an operation with respect to the DEP; and considering that an action exploiting the vulnerability has occurred in the system when an operation to close the DEP is detected. The invention also discloses a corresponding vulnerability monitoring apparatus.

### FIELD OF THE INVENTION

The invention relates to the field of computer network security, and in particular, to an apparatus and method for detecting vulnerability based on data execution protection (DEP).

### BACKGROUND OF THE INVENTION

With the development of the computer network, the network application becomes increasingly popular. Since inevitably there are vulnerabilities in the operating system and application layer software of network servers on which network applications reside, hackers may illegally invade these network servers by exploiting these vulnerabilities, thereby bringing about a great threat to the network applications, especially to the property of users using these network applications.

The procedure exploiting the vulnerability generally comprises two parts: triggering the vulnerability and executing a shellcode. Firstly, a hacker will trigger the vulnerability on a target machine, and then successfully invade the target machine by executing a shellcode after triggering the vulnerability. The shellcode is a small piece of code used in the procedure of exploiting the vulnerability. Since generally the code will start a command line console in order that the hacker may utilize the console to control the invaded machine, the piece of code is called the shellcode in the field of network security. One typical procedure of exploiting the vulnerability is as follows: firstly, the vulnerability in a certain process on a target machine is utilized to obtain control of an instruction register, and a shellcode is inserted into the process simultaneously or in advance, then the instruction register is adjusted to point to the shellcode, and thereby the shellcode is executed to successfully invade the target machine.

Since the way in which the vulnerability is triggered will vary with a particular vulnerability, detection of the action triggering the vulnerability also needs to be processed differently with respect to the different vulnerabilities. As a result, there is not yet a unified way to monitor illegal operations exploiting the vulnerability on a target machine.

Since apparatuses (e.g., a network server and a client, etc.) employing the Microsoft Windows operating system are increasing, it becomes an increasingly important issue with respect to how to monitor illegal operations exploiting the vulnerability on the apparatuses.

The current Microsoft Windows operating system employs a security technology called data execution protection (DEP) in combination with software and hardware to prevent an application or service residing on the operating system from executing a code from nonexecutable memory area. In most network apparatuses employing the Microsoft Windows operating system, the data execution protection (DEP) has been enabled to enhance system security.

However, in existing apparatuses employing the Microsoft Windows operating system, there is not yet a method and apparatus enabled to monitor illegal operations exploiting the vulnerability in these apparatuses comprehensively and efficiently.

To this end, there needs a new vulnerability monitoring apparatus and method which may monitor such illegal operations exploiting the vulnerability in a unified, comprehensive and efficient way.

### SUMMARY OF THE INVENTION

In view of the above problems, the invention is proposed to provide a vulnerability detecting apparatus and method which may overcome the above problems or at least in part solve or mitigate the above problems.

The applicant have noticed that, in an apparatus in which the Microsoft Windows operating system is employed and the data execution protection (DEP) is enabled, in the procedure of exploiting the vulnerability, a shellcode is usually located in a data area marked as “nonexecutable”, and the action to directly execute the shellcode will trigger an exception, which will ultimately lead to the execution failure of the shellcode. This results in that, if the shellcode will be executed normally, a closing or bypassing operation must be performed on the DEP. If the operation to close the DEP may be monitored, then an exceptional action exploiting the vulnerability in the apparatuses may be detected, and the invention is made based on this.

According to an aspect of the invention, there is provided a vulnerability monitoring method for performing a vulnerability monitoring on a system in which data execution protection (DEP) is enabled, which method comprises the steps of: monitoring an operation with respect to the data execution protection (DEP); and considering that an action exploiting a vulnerability has occurred in the system when an operation to close the data execution protection (DEP) is detected.

Optionally, the monitoring the operation with respect to the data execution protection (DEP) comprises monitoring any of one or more functions necessary for closing the data execution protection in the system. Additionally, these functions may be any one or both of NtSetInformationProcess( )and NtSetSystemInformation( ). Since the operation to close the DEP generally needs to be implemented by calling a certain function number of such functions as NtSetInformationProcess( ) and NtSetSystemInformation( ) etc., the objective to monitor the action attempting to execute a shellcode may be achieved by monitoring a call of such functions.

Furthermore, the hook technology can be used to handle the monitoring of any of one or more functions necessary for closing the data execution protection in the system. The hook is a point in the message handling mechanism of the Windows operating system, and at this point, some subroutines may be inserted to monitor a message or modify the message before it reaches the destination application. A technology utilizing a hook is generally called the hook technology, which is a technology commonly used in security software. The hook technology may realize functions such as audit and access control of a software code, etc. by modifying the execution flow of the software code. In a Windows operating system, monitoring a particular function may be accomplished by utilizing the hook technology.

According to another aspect of the invention, there is provided a vulnerability monitoring apparatus for performing a vulnerability monitoring on a system in which data execution protection (DEP) is enabled, which apparatus comprises: a monitoring unit adapted for monitoring an operation with respect to the data execution protection (DEP); and a judgment unit adapted for deciding that an action exploiting the vulnerability has occurred in the system when the monitoring unit detects an operation to close the data execution protection (DEP).

The vulnerability monitoring method and apparatus according to the invention takes it into account that, in a system in which DEP is enabled, an illegal operation exploiting the vulnerability existing in the system generally needs to close the DEP before executing the shellcode, and therefore may efficiently monitor such illegal operations by monitoring the operation with respect to the DEP, and provides a unified way to monitor these illegal operations.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the invention. And throughout the drawings, like reference signs are used to denote like components. In the drawings:

FIG. 1 shows schematically a flow chart of a vulnerability monitoring method according to an embodiment of the invention;

FIG. 2 shows schematically a block diagram of a vulnerability monitoring apparatus according to an embodiment of the invention;

FIG. 3 shows schematically a block diagram of a computer for carrying out a method according to the invention; and

FIG. 4 shows schematically a storage unit for maintaining or carrying a program code implementing a method according to the invention.

### DETAILED DESCRIPTION OF THE INVENTION

In the following the invention will be further described in connection with the drawings and the particular embodiments.

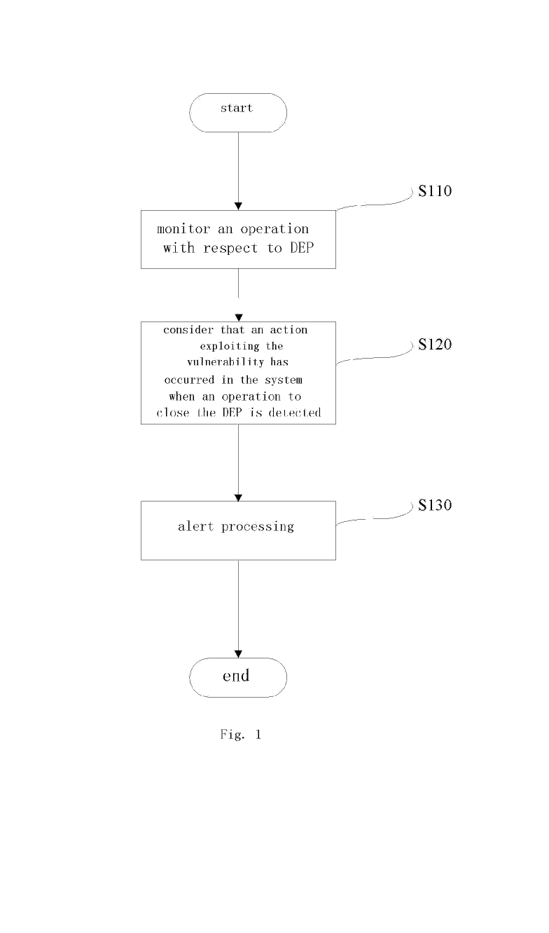

FIG. 1 shows a flow chart of a vulnerability monitoring method 100 according to an embodiment of the invention. The vulnerability monitoring method 100 is adapted for performing the vulnerability monitoring on an apparatus employing a system in which data execution protection (DEP) is enabled. And the system in which the DEP is enabled is generally a Microsoft Windows operating system. As shown in FIG. 1, the method begins at step S110, wherein all the operations with respect to the DEP in the system are monitored. As described above, in a system in which DEP is enabled, a malicious action exploiting the vulnerability must close the DEP in order to be able to execute a shellcode, and therefore these malicious actions may be found timely by monitoring the operations with respect to the DEP.

Optionally, in a Microsoft Windows operating system, an operation with respect to DEP, especially the operation to close the DEP, inevitably involves one or more system functions. For this reason, a monitoring operation may comprise monitoring at least one of one or more functions necessary for closing the DEP. For example, these functions may be NtSetInformationProcess( ) and NtSetSystemInformation( ). Of course, with the development of the Windows operating system, these functions may not be limited to the particular functions mentioned above. Hence, all the functions involved in closing the DEP fall within the protection scope of the invention.

Optionally, in the Windows operating system, a hook technology may be employed in order to monitor a function, i.e., monitor a certain point in the message handling mechanism of the operating system, to monitor calls for these functions as well as the message content involved in the calls. In particular, according to an embodiment, a module may be loaded in the kernel of the operating system, which module makes a hook on the function NtSetInformationProcess( ) and/or NtSetSystemInformation( ) in the SSDT (system service descriptor table), especially the related function numbers in these functions. If there is an action to call these functions, analyzing a parameter for calling these functions to determine whether it is an action to close the DEP.

Subsequently, at step S120, when an operation to close the DEP is detected at step S110, it is considered that an action exploiting the vulnerability has occurred in the target system. Optionally, at step S130, the detected action exploiting the vulnerability is informed to the system administrator in various ways, which, for example, comprise recording the actions in a log, issuing a warning to inform the system administrator, and the like. It should be noted that, any other ways that may be employed in the target system to record and/or inform the system administrator of the actions exploiting the vulnerability fall within the protection scope of the invention.

The vulnerability monitoring method according to the invention may effectively detect the action to perform an operation exploiting the system vulnerability in the target system by monitoring the operation to close DEP.

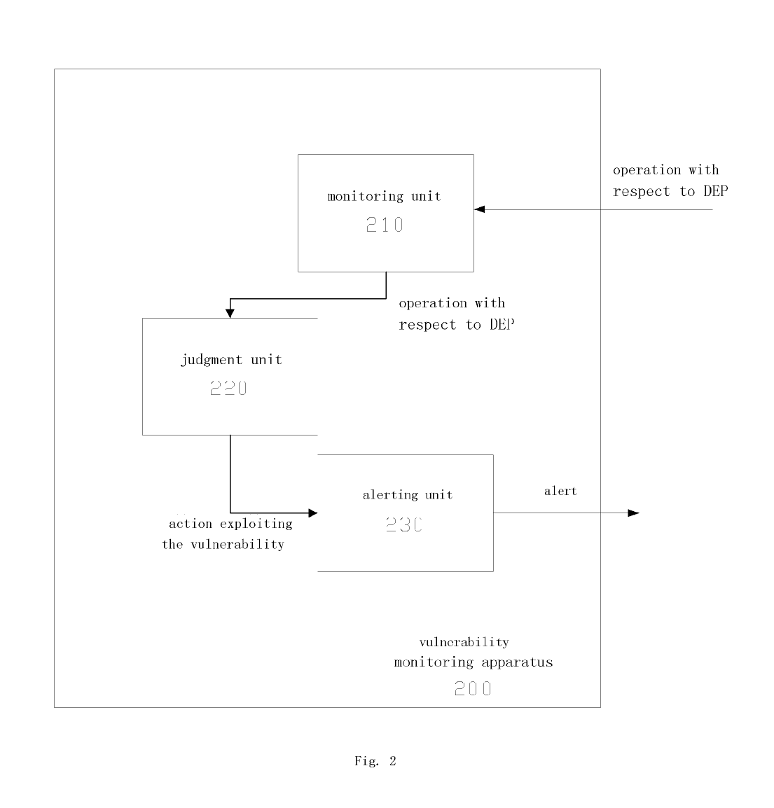

FIG. 2 shows schematically a block diagram of a vulnerability monitoring apparatus 200 according to an embodiment of the invention. The vulnerability monitoring apparatus 200 is adapted for performing the vulnerability monitoring on the apparatus employing the system in which data execution protection (DEP) is enabled. As shown in FIG. 2, the vulnerability monitoring apparatus 200 comprises a monitoring unit 210 and a judgment unit 220.

The monitoring unit 210 is adapted for monitoring an operation with respect to the DEP. As described above, in the system in which DEP is enabled, a malicious action exploiting the vulnerability has to close the DEP in order to be able to execute a shellcode, and therefore the monitoring unit 210 may find these malicious actions timely by monitoring the operations with respect to the DEP.

Optionally, in the Microsoft Windows operating system, the operation with respect to the DEP, especially the operation to close the DEP, inevitably involves one or more system functions. As such, the monitoring unit 210 may monitor at least one of one or more functions necessary for closing the DEP. For example, these functions may be NtSetInformationProcess( ) and NtSetSystemInformation( ). Of course, with the development of the Windows operating system, these functions may not be limited to the particular functions mentioned above. All the functions involved in closing the DEP fall within the protection scope of the invention.

Optionally, in a Microsoft Windows operating system, a hook technology may be employed in order to monitor the functions, i.e., monitor a certain point in the message handling mechanism of the operating system, to monitor calls for these functions as well as the message content involved in the calls. In particular, according to an embodiment, the monitoring unit 210 may comprise a module loaded in the kernel of the operating system, which module makes a hook on the function NtSetInformationProcess( ) and/or NtSetSystemInformation( ) in the SSDT (system service descriptor table), especially the related function numbers in these functions. If there is an action to call these functions, analyzing the parameters calling these functions to determine whether it is an action to close the DEP. Generally speaking, the monitoring unit 210 may perform step S110 of the monitoring method described above.

The judgment unit 220 analyzes the operation monitored by the monitoring unit 210. When the monitoring unit 210 detects an operation to close the DEP, the judgment unit 220 decides that an action exploiting the vulnerability has occurred in the target system. Optionally, the judgment unit 220 sends the judgment result to an alerting unit 230, so that the alerting unit 230 informs the system administrator of the detected action exploiting the vulnerability in various ways, which, for example, comprise recording the actions in a log, issuing a warning to inform the system administrator, and the like. It should be noted that, any other ways that may be employed in the target system to record and/or inform the system administrator of the action exploiting the vulnerability fall within the protection scope of the invention. Generally speaking, the judgment unit 220 may perform step S120 of the monitoring method described above, and the alerting unit 230 may perform step S130 of the monitoring method described above.

The vulnerability monitoring apparatus 200 according to the invention may effectively detect the action to perform the operation exploiting the system vulnerability in a target system by monitoring the operation to close DEP.

It is to be noted that, in individual components of the vulnerability monitoring apparatus 200 of the invention, the components therein are divided logically according to the functions to be realized by them, however, the invention is not limited thereto, and individual components may be re-divided or combined as needed, for example, some components may be combined into a single component, or some components may be further divided into more sub-components.

Embodiments of the individual components of the invention may be implemented in hardware, or in a software module running on one or more processors, or in a combination thereof. It is appreciated by those skilled in the art that, in practice, some or all of the functions of some or all of the components in a website scanning apparatus according to an embodiment of the invention may be realized using a microprocessor or a digital signal processor (DSP). The invention may also be implemented as an apparatus or a device program (e.g., a computer program or a computer program product) for carrying out a part or all of the method described herein. Such a program implementing the invention may be stored on a computer readable medium, or may be in the form of one or more signals. Such a signal may be obtained by downloading it from an Internet website, or provided on a carrier signal, or provided in any other forms.

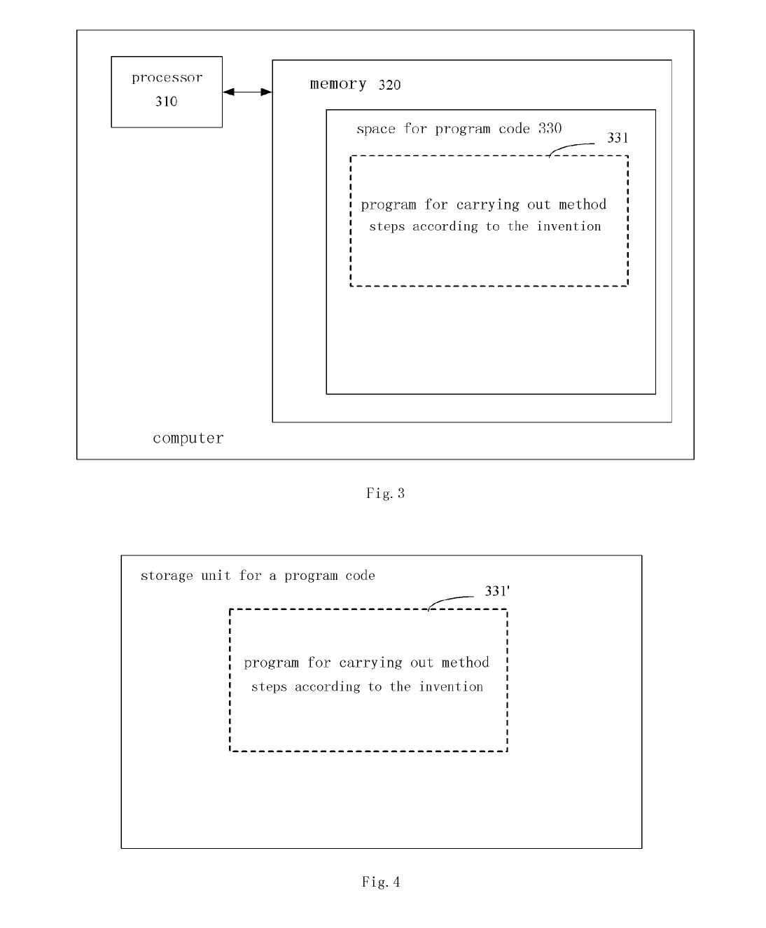

For example, FIG. 3 shows a computer, e.g., an application server which may carry out a network scanning method according to the invention. The computer traditionally comprises a processor 310 and a computer program product or a computer readable medium in the form of a memory 320. The memory 320 may be an electronic memory such as a flash memory, an EEPROM (electrically erasable programmable read-only memory), an EPROM, a hard disk or a ROM. The memory 320 has a memory space 330 for a program code 331 used for carrying out any method steps of any one of the methods as described above. For example, the memory space 330 for the program code may comprise individual program codes 331 for carrying out individual steps in the above methods respectively. These program codes may be read from or written to one or more computer program products. These computer program products comprise such a program code carrier as a hard disk, a compact disk (CD), a memory card or a floppy disk. Such a computer program product is generally a portable or stationary storage unit as described with reference to FIG. 4. The storage unit may have a memory segment, a memory space, etc. arranged similarly to the memory 320 in the computer of FIG. 3. The program code may for example be compressed in an appropriate form. In general, the storage unit comprises computer readable codes 331′, i.e., codes which may be read by a processor such as 310, and when being executed by a server, these codes cause the server to carry out individual steps in the methods described above.

It is to be noted that the above embodiments illustrate rather than limit the invention, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several devices, several of the devices may be embodied by one and the same hardware item. Use of the words first, second, and third, etc. does not mean any ordering. Such words may be construed as naming.

1. A vulnerability monitoring method for performing a vulnerability monitoring on a system in which data execution protection (DEP) is enabled, comprising the steps of:
monitoring an operation with respect to the data execution protection (DEP); and
considering that an action exploiting a vulnerability has occurred in the system when detecting an operation to close the data execution protection (DEP).

2. The vulnerability monitoring method as claimed in claim 1, wherein the monitoring the operation with respect to the data execution protection (DEP) comprises:
monitoring at least one of one or more functions necessary for closing the data execution protection in the system.

3. The vulnerability monitoring method as claimed in claim 2, wherein the one or more functions necessary for closing the data execution protection comprise NtSetInformationProcess ( ) and NtSetSystemInformation( ).

4. The vulnerability monitoring method as claimed in claim 3, wherein the monitoring the operation with respect to the data execution protection (DEP) comprises:
performing a hook processing on any of one or more functions necessary for closing the data execution protection in the system.

5. The vulnerability monitoring method as claimed in claim 1, further comprising the step of:
recording the action exploiting the vulnerability in a log or issuing a warning to inform a system administrator of a message regarding the action, when it is considered that the action has occurred in the system.

6. A vulnerability monitoring apparatus for performing a vulnerability monitoring on a system in which data execution protection (DEP) is enabled, comprising:
a monitoring unit adapted for monitoring an operation with respect to the data execution protection (DEP); and
a judgment unit adapted for deciding that an action exploiting the vulnerability has occurred in the system when the monitoring unit detects an operation to close the data execution protection (DEP).

7. The vulnerability monitoring apparatus as claimed in claim 6, wherein the monitoring unit is adapted for monitoring any of one or more functions necessary for closing the data execution protection in the system.

8. The vulnerability monitoring apparatus as claimed in claim 7, wherein the one or more functions necessary for closing the data execution protection comprise any one or both of NtSetInformationProcess( )and NtSetSystemInformation( ).

9. The vulnerability monitoring apparatus as claimed in claim 8, wherein the monitoring unit is adapted for performing a hook processing on any of one or more functions necessary for closing the data execution protection in the system.

10. The vulnerability monitoring apparatus as claimed in claim 6, further comprising:
an alerting unit adapted for recording an action exploiting a vulnerability in a log or issuing a warning to inform a system administrator of a message regarding the action when the judgment unit considers that the action has occurred in the system.

11. The vulnerability monitoring method as claimed in claim 1, wherein a computer program comprising a computer readable code runs on a server, causing the server to carry out the vulnerability monitoring method.

12. The vulnerability monitoring method of claim 11, wherein the computer program is stored on a computer readable medium.

13. The vulnerability monitoring method as claimed in claim 2, wherein the monitoring the operation with respect to the data execution protection (DEP) comprises:
performing a hook processing on any of one or more functions necessary for closing the data execution protection in the system.

14. The vulnerability monitoring apparatus as claimed in claim 7, wherein the monitoring unit is adapted for performing a hook processing on any of one or more functions necessary for closing the data execution protection in the system.

15. The vulnerability monitoring method as claimed in claim 2, wherein a computer program comprising a computer readable code runs on a server, causing the server to carry out the vulnerability monitoring method.

16. The vulnerability monitoring method as claimed in claim 3, wherein a computer program comprising a computer readable code runs on a server, causing the server to carry out the vulnerability monitoring method.

17. The vulnerability monitoring method as claimed in claim 4, wherein a computer program comprising a computer readable code runs on a server, causing the server to carry out the vulnerability monitoring method.

18. The vulnerability monitoring method as claimed in claim 5, wherein a computer program comprising a computer readable code runs on a server, causing the server to carry out the vulnerability monitoring method.

19. The vulnerability monitoring method as claimed in claim 6, wherein a computer program comprising a computer readable code runs on a server, causing the server to carry out the vulnerability monitoring method.

20. The vulnerability monitoring method as claimed in claim 15, wherein the computer program is stored on a computer readable medium.
